(19) United States
(12) Patent Application Publication
(10) Pub. No.: US 2022/0027990 A1
(43) Pub. Date: Jan. 27, 2022

(54) TRADING SCHEDULE MANAGEMENT SYSTEM

(71) Applicant: Element AI Inc., Montreal (CA)

(72) Inventors: Pascal BERGERON, Montreal (CA); Nicolas CHAPADOS, Montreal (CA); Étienne MARCOTTE, Montreal (CA); Marek SABATA, Montreal (CA); Ivan SERGIENKO, Montreal (CA); Richard Anthony VALENZANO, Montreal (CA); Benjamin CRESTEL, Montreal (CA)

(73) Assignee: Element AI Inc., Montreal, QC (CA)

(21) Appl. No.: 17/275,813

(22) PCT Filed: Sep. 13, 2019
(86) PCT No.: PCT/CA2019/051300

§ 371 Date: Mar. 12, 2021

Related U.S. Application Data
(60) Provisional application No. 62/731,544, filed on Sep. 14, 2018.

(51) Int. Cl. G06Q 40/04; G06N 20/00; G06Q 30/02

(52) U.S. Cl. CPC G06Q 40/04; G06Q 30/0206; G06Q 30/0201; G06N 20/00

(57) ABSTRACT

Systems and methods for managing an asset portfolio. A system generates a detailed trading schedule that converts a current portfolio into a desired portfolio. The schedule is generated using machine learning and is based on a number of inputs including the current portfolio, a desired portfolio, an execution timeline, as well as user supplied constraints. Once generated, the system evaluates the schedule using one or more market models to determine if the schedule will be feasible given market reactions based on the one or more models. The system iterates the generation/evaluation loop until the best possible schedule is arrived at. In addition, the system may provide recommendations for not only brokers to be used when executing the trades but also trading algorithms that the brokers may use when implementing the schedule.

### TECHNICAL FIELD

The present invention relates to the management of financial assets. More specifically, the present invention relates to systems and methods for scheduling, managing, and executing financial asset trades with the aid of machine learning.

### BACKGROUND

Buy side asset managers such as sovereign wealth funds, pension funds, hedge funds and the like provide investment services directly to Investors. Investors give asset managers high-level objectives, such as retirement income, and constraints, such as loss tolerance and asset class allocations. Asset managers then decide in which specific securities to invest client assets. Buy side firms need to both invest new cash coming from investors and to rebalance their portfolios on a periodic basis to stay within the investment mandates provided by investors. Once an asset manager decides what to trade, it gives the trading instructions to sell side stock broker firms. The trading instructions are typically relatively high-level, such as, for example, “Buy 100,000 shares of Apple over 5 days”. An asset manager usually has a choice of stock brokers to whom the order is routed. Each stock broker will then execute their respective orders on one or more exchanges.

As can be imagined, asset managers, investors, and large financial institutions wish to optimize the processes involved in the rebalancing, management, and execution of asset trades. Quite a number of considerations are usually taken into account when considering the issues. Not only would the constraints imposed by the investors and managers need to be addressed but even the question of which brokers to use may need to be addressed. In addition, the timing, quantity of assets, and the buy/sell prices for such assets must also be factored into whatever strategy is being used.

Development of algorithmic trading strategies over the last decade has been disproportionately concentrated on the sell side, particularly in large investment banks. The investment banks have the resources and direct incentives to take advantage of efficiency savings provided by algorithms. In turn, buy side firms have remained relatively in the dark about the full cost of trading. That is largely because they have not had to report these costs back to investors in great detail. Accordingly, there is a need for systems and methods that address the needs on the buy side as well as on the asset management side.

### SUMMARY

The present invention provides and methods for managing an asset portfolio. A system generates a detailed trading schedule that converts a current portfolio into a desired portfolio. The schedule is generated using machine learning and is based on a number of inputs including the current portfolio, a desired portfolio, an execution timeline, as well as user supplied constraints. Once generated, the system evaluates the schedule using one or more market models to determine if the schedule will be feasible given market reactions based on the one or more models. The system iterates the generation/evaluation loop until the best possible schedule is arrived at. In addition, the system may provide recommendations for not only brokers to be used when executing the trades but also trading algorithms that the brokers may use when implementing the schedule.

In a first aspect, the present invention provides a system for use in managing a portfolio of financial assets, the system comprising:
an input module for receiving input data, said input data comprising:
   current portfolio data comprising details regarding assets in a current portfolio;
   desired portfolio data comprising details regarding assets in a desired portfolio;
   execution time data comprising details for at least an execution time window during which said current portfolio is to be converted into said desired portfolio;
   portfolio management constraints detailing constraints that need to be followed when converting said current portfolio into said desired portfolio;
a management scheduler module receiving said input data, said scheduler module being for generating an asset management schedule, said asset management schedule including limits for buying and selling said assets in said current portfolio and in said desired portfolio;
an evaluator module for evaluating said asset management schedule based on a suitability of said asset management schedule for execution of one or more specific tasks;
wherein
said one or more specific tasks includes an optimization of an increase in asset value differences between said assets in said current portfolio and said assets in said desired portfolio;
said schedule subdivides said execution time window into specific time units and said schedule details one or more assets to be bought or sold within specific time units.

In a second aspect, the present invention provides a method for managing a financial asset portfolio, the method comprising:
receiving a trade order including at least one asset type, a corresponding portfolio weight envelope, and a corresponding execution timeline;
converting the portfolio weight envelope for the at least one asset type into a desired asset quantity envelope;
dividing the timeline into a plurality of expected trading sessions for at least one specific market;
distributing the desired asset quantity envelope among the number of expected trading sessions; and
issuing at least one instruction to at least one broker, said at least one instruction being indicative of at least one distributed quantity to be traded during at least one of the plurality of trading periods.

### BRIEF DESCRIPTION OF THE DRAWINGS

The present invention will now be described by reference to the following figures, in which identical reference numerals refer to identical elements and in which:

FIG. 1 is a block diagram of a system according to one aspect of the present invention;

FIG. 2 is another block diagram of a similar system to that illustrated in FIG. 1; and

FIG. 3 is a flowchart detailing the steps in a method according to another aspect of the present invention.

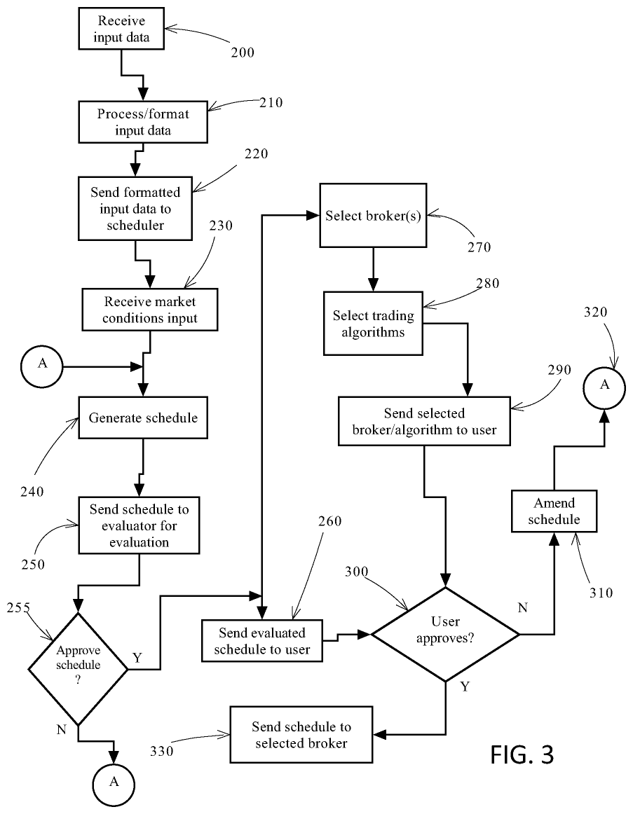

### DETAILED DESCRIPTION

In one aspect, the present invention provides a system and method for managing financial assets. In one implementation, the system is used for rebalancing an asset portfolio by receiving input from a user regarding a current asset portfolio, a desired asset portfolio, constraints regarding the trades needed to convert or produce the desired asset portfolio from the current asset portfolio, and a time window in which to accomplish this. The system may produce a detailed schedule that divides the time window into smaller time units, details which assets to sell at which time unit within the time window, which assets to buy at which time unit within the time window, which asset exchanges to use when buying or selling assets, and the price limits under which the buy/sell instructions are to be executed. The schedule may also include which exchanges are to be used in which asset buy/sell transactions. In one alternative, the schedule may also detail which broker and which trading algorithm is to be used for which transaction. The resulting schedule is sent to a user for approval. Once approved, the relevant parts of the schedule are sent to the relevant brokers for execution.

It should be noted that, once the schedule is produced, this generated schedule is evaluated based on the overall context, the prices of the assets, and the expected volume of the asset purchases/sales. Evaluation is performed to determine if the schedule produces the desired end result, a suitable desired portfolio with appropriately valued assets. This evaluation may be based on one or more models that seek to mimic or replicate market or exchange behaviour when subjected to the trades in the generated schedule. To ensure that the evaluation is performed on the correct bases, the input data entered by the user, including the current and desired portfolios and the constraints noted above may be used in this evaluation. Should the evaluation prove that the generated schedule is insufficient or does not meet the desired needs, a feedback loop causes a modified schedule to be generated. New or modified schedules are iteratively generated using feedback from the evaluator to generate the best possible schedule based on the input data and on the context of that data. Depending on the implementation, the evaluation may also be performed based at least on one or more market condition inputs as will be detailed below.

To assist in the generation of the schedule, the system may receive a market condition input that details conditions in one or more asset trading markets or exchanges. These conditions may thus be used when generating the schedule or when evaluating the schedule generated. The market condition input may be a real-time or near real-time input from the actual market(s) or exchange(s) being monitored. Alternatively, the market conditions may be the result of a simulation of such markets or exchanges. A suitable market/exchange simulator can thus provide the data necessary to provide the system with the necessary input regarding market conditions. It should be clear that the market condition input may be limited to a single market/exchange or it may details the conditions to multiple markets or exchanges.

As noted above, the choice of a broker or brokers to use when executing the trades may be important. Not only would the cost of the broker's fees factor into the efficiency of the execution of the rebalancing strategy but the past performance of the broker in previous trades or transactions may also be used as an indicator of the chances of successfully executing the trades within the schedule. Accordingly, a broker selection module may be present in the system to assist in recommending a broker or brokers to execute the sales/purchases of assets according to the generated schedule. In addition to recommending one or more brokers to use, the system can also provide recommendations as to which of that broker's trading algorithms may be most advantageous to use when executing the various trades. To assist in the recommendations, the broker selection module may be coupled to a database containing details and data regarding a number of brokers, their past transactions, results of these transactions, the costs of asset sales and asset purchases through specific brokers, as well as data regarding the trading algorithms used by these brokers. A detailed history of these trading algorithms as well as the performance of these algorithms may also be stored in the database. The system, perhaps through the broker selection module, can access the data in the database and, by analyzing the history, costs, and performance of each broker as well as its trading algorithms, can provide a recommendation for which broker or brokers to use. As well, the system can recommend which algorithms to use for each broker.

Once the detailed schedule has been generated and evaluated to be suitable, the schedule is then transmitted to the user by way of a suitable GUI (graphical user interface) or API (application programming interface). The user can then accept or reject the schedule. If the user has accepted the schedule, the schedule can then be sent to the selected brokers for execution. Of course, if the schedule has been rejected, then the user can modify/adjust the schedule and send the schedule back to the system for further work.

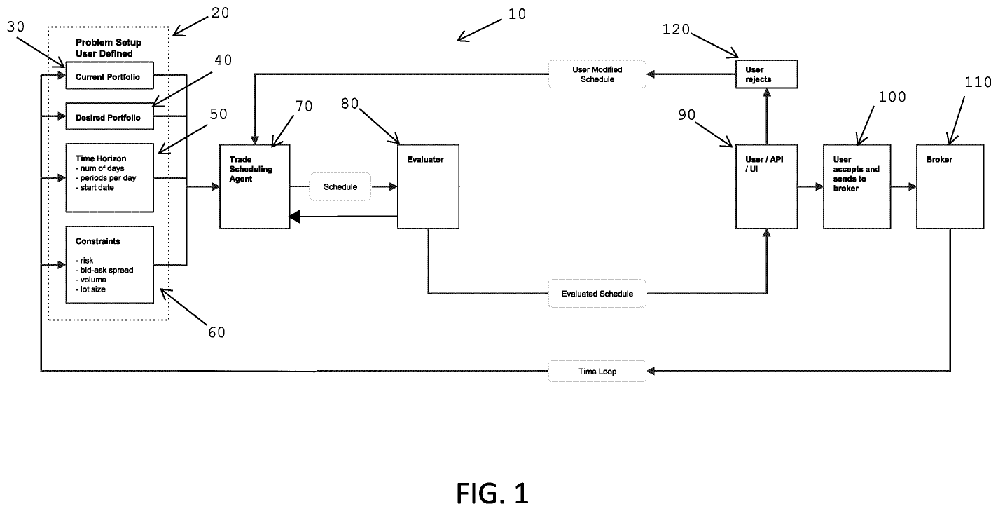

Referring to FIG. 1, a block diagram of a base system according to one aspect of the invention is illustrated. As can be seen in FIG. 1, the system 10 includes an input module 20 that receives input data that includes current portfolio data 30, desired portfolio data 40, execution time data 50, and constraints 60. The current portfolio data 30 provides details regarding the assets in a current portfolio, including at least the identity of these assets and perhaps the price of such assets. Similarly, the desired portfolio data 40 provides details regarding the assets in a desired portfolio. The execution time data provides a time frame in which the current portfolio is to be converted/adjusted to result in the desired portfolio. The execution time data provides, at the very least, a deadline by which the conversion is to be accomplished or, alternatively, a time line or time units into which the execution time window is to be divided into (e.g. how many days, the division into what time units, how many smaller units per large time units, etc., etc.). Thus, as an example, the execution time data can detail that the time window of 10 working or trading days is to be divided into 100 time units and that, as such, a number of trades/sales/purchases may need to be performed per time unit.

Also included in the input data are constraints that have to be adhered to when executing the trades necessary to convert the current portfolio into the desired portfolio. Any number of constraints may be entered and these constraints may relate to any aspect of the conversion of the current portfolio into the desired portfolio. Constraints may relate to the level of risk, a bid-ask spread, a volume of assets to be sold/purchased, and to an asset lot size. As further examples, the constraints may include a maximum buying price for at least one specific asset in said desired portfolio, a minimum selling price for at least one specific asset in said current portfolio, a maximum number of assets to be bought per transaction, a minimum number of assets to be sold per transaction, a maximum number of assets to be sold per transaction, and a minimum number of assets to be bought per transaction. Other constraints can be related to participation rate and relative trade volumes per available volume of the assets on the market. Similarly, constraints may also relate to the amount of assets to be sold/purchased per time unit or per day or trading time period. Similarly, if the implementation includes the broker selection module, the constraints may include limits on the price per transaction charged by the broker, minimal performance levels required of brokers to be selected, minimal performance levels of trading algorithms to be selected, as well as a maximum costs for brokers' fees for the portfolio conversion.

Once the input data has been entered into the input module 20 and once the input data has been properly formatted and processed such that it is suitable for use by the system, the input data is transferred to the trade scheduler module 70. The trade scheduler module 70 then takes the input data, analyzes that data and generates the schedule. The trade scheduler module 70 may use algorithms/methods based on a combination of neural networks, dynamic programming, constrained optimization methods, time series forecasting, transfer learning, Bayesian inference, and/or reinforcement learning to produce the schedule. The module 70 can use various methods and means to generate the schedule to optimally buy or sell assets for each trading session within the trading execution time window. Thus, as an example, if the time window is 5 days, then the module can determine that x shares of stock x₁ are to be sold in day 1, y shares of y₁ are to be bought on day 2, etc., etc. until all the necessary sales and purchases of assets have been completed within the 5 day time window. As can be imagined, the trade scheduler module 70 may take into account a suitable market impact model that assesses the market impact of any or all of the asset trades. Such a model can also be used to adjust the schedule to ensure that an optimal change in the value of the portfolio is achieved (i.e. the increase in value between the assets in the current portfolio and the assets in the desired portfolio is maximized). In addition, the trade scheduler module 70 can take into account one or more suitable risk models that mimic or predict the risk that each of the trades engender. Depending on the desired risk profile, the risk may be minimized or it may be adjusted as necessary based on the risk model.

It should be clear that, as part of the functions of the trade scheduler module 70, the input data may be checked for consistency. As such, the constraints may be checked by the trade scheduler module 70 to ensure that the constraints do not contradict each other. As well, the trade scheduler module 70 may also be used to check the generated schedule so as to ensure that the schedule adheres to the various constraints entered.

Once the schedule has been generated, this schedule is then evaluated by an evaluator module 80 that evaluates the schedule using a number of criteria with the aid of a number of market/exchange models. The evaluator module 80 determines if the generated schedule conforms to the various constraints (if possible). As well, the evaluator module assesses the schedule in light of the overall context such as market conditions, suitability for the intended use (e.g. if the schedule details trade in too large a volume of a specific asset in a small amount of time, then this may adversely affect that price of that asset), and whether it produces the desired portfolio in the end. As noted above, the evaluator module would assess the generated schedule based on one or more models for exchange/market behaviour.

If the generated schedule is assessed to be insufficient or lacking in some way by the evaluator module 80, feedback from the evaluator module 80 is sent back to the trade scheduler module and the previous schedule is either discarded or is sent back to the scheduler module. The trade scheduler module 80 then uses the feedback (or the previously generated schedule) to generate an updated schedule that has been updated based on the feedback. This iterative process continues until the evaluator module assesses the iterated schedule to be satisfactory (i.e. the schedule is the best possible schedule given the input data, the constraints, the context, and the market conditions as the scheduler can no longer improve on the schedule). Note that, depending on the implementation, the assessment as to whether a generated schedule conforms to the constraints may occur either at the evaluator module or at the trade scheduler module.

When the schedule has been evaluated and is considered to be acceptable (perhaps after a number of iterations between the trade scheduler module and the evaluator module), the generated schedule is then passed to a user by way of a GUI or an API 90. The user then performs his or her own evaluation of the generated schedule. Upon approval 100, the schedule is sent to one or more brokers 110 and the broker or brokers then executes according to the schedule. Should the schedule need amendment, the user amends the schedule and rejects the previous version of the schedule 120. The user modified schedule is then returned back to the trade scheduler module 70 for further amendments and a new schedule is generated.

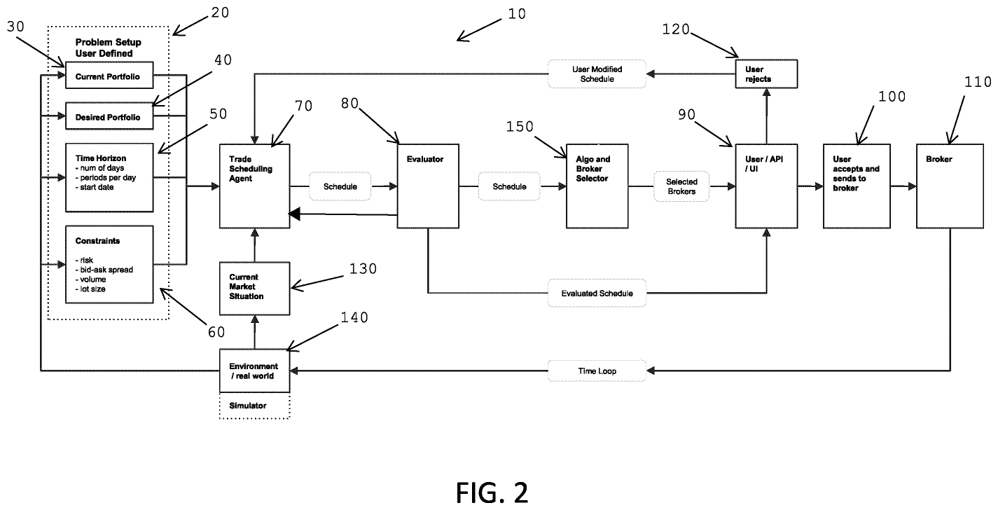

Referring to FIG. 2, a more robust version of the system is illustrated. In this version, a more accurate schedule is generated as the current market conditions input is received and used by the trade scheduler module 70. As well, this version of the system generates recommendations for which broker or brokers to use along with which trading algorithms to use with that broker.

In FIG. 2, the trade scheduler module 70 receives a market condition input from a market situation module 130. The market situation module 130 can be used to generate input that indicate market conditions using various models that designed to mimic or copy market behaviour or exchange behaviour. Thus, depending on which model one wishes to use to mimic market behaviour the market situation module 130 can produce suitable data that can be used as the market condition input for the trade scheduler module 70. Alternatively, the market situation module 130 can receive data that helps it create/format data that can be used as the market condition input. For this, a module 140 produces such data that can be turned into the market condition input. This module 140 may be real-time data based or near real-time data based such that it receives data from existing markets and/or exchanges. This data (possibly including the prices of specific assets, the values of specific indices such as the Dow Jones Industrial Average, the NASDAQ Composite, or the FTSE 100 Index) is received by the module 140 and then packaged and formatted to be sent to the market situation module 130. The market situation module 130 then creates a data set, based on the data received from the module 140, that is used as the market condition input.

In another alternative, instead of receiving real-world data from various real-world exchanges and/or markets, the module 140 may generate such market/exchange data by itself. This can be done by having a simulator sub-module within the module 140 with the simulator generating the data that would otherwise be received concerning the various exchanges/markets. It should be clear that the data either generated by the simulator or received by the module 140 forms part of the context by which the evaluator module 80 assesses the generated schedule. This would ensure that the schedule generated is internally consistent with the data/conditions that were used to generate it in the first place.

It should also be clear that, in FIG. 2, the system generates recommendations for specific brokers to be used when executing the asset trades/sales/purchases in the schedule. Once the evaluator module 80 has approved of the generated schedule, this schedule is sent to the user by way of the GUI/API 90. Separately but in parallel, the evaluator module 80 sends the approved schedule to a broker selection module 150. The broker selection module 150 then receives the approved schedule and, based on the data in the schedule, generates recommendations as to the broker or brokers that would be most suitable to execute the asset trades listed in the schedule. This can be done by assessing at least one of: the previous records of transactions of various brokers, the specific types of trades listed in the schedule, the volume of the trades in the schedule, the timeline of the trades in the schedule, the costs associated with using specific brokers (e.g. the cost per trade for specific brokers or the commission charged by each broker), and the algorithms that each broker may use for the trades in the schedule. Then, based on the analysis and the criteria for selecting one of more brokers (e.g. minimizing broker fees, maximizing trades per time unit, the suitability of algorithms used by a broker, a suitable past history of trading in one or more relevant exchanges, etc.), the broker selection module 150 outputs one or more brokers that are recommended to execute the trades in the generated schedule. In addition, the broker selection module 150 can also output which algorithms are to be used by which broker for the execution of the trading/rebalancing strategy as detailed in the generated schedule.

From the above, it should be clear that, to generate recommendations for the brokers and their trading algorithms, the broker selection module 150 has access to a database of each broker's trading history as well as a history for each of the algorithms used by each broker. The module 150 can then base its recommendations on the history of the broker, the history of the various algorithms, as well as the contents of the generated schedule.

Once the listing of the selected brokers has been transmitted to the GUI/API 90, the user can then assess the approved schedule as well as the recommendations for the brokers. Of course, the user can accept or reject these recommendations as well as the details of the generated schedule. It should be noted that the user may reject and/or amend some or all of the data received by way of the GUI/API 90. Should the user approve of both the broker/algorithm recommendations and the generated schedule, the user can approve this material and have this passed on to the selected broker(s) for execution. However, if the user does not approve of the generated schedule and amends the parameters detailed in the input data to thereby change one or more of the constraints and/or the portfolio data, the amended parameters (and possibly the schedule) are sent back to the trade scheduler module 70. The trade scheduler module 70 then generates a new schedule based on the amended parameters (i.e. based on an amended set of input data). However, if the user only amends a small portion of the schedule and/or parameters such that the input data (i.e. the constraints and the portfolio data) is not significantly changed and such that a new schedule does not need to be generated, then the amended schedule may be allowed to pass through to the brokers for execution. Similarly, if the user approves of the generated schedule but does not approve of the broker and/or algorithm recommendations, then this feedback is sent to the broker selection module 150 so that a new broker/algorithm may be selected. However, the already approved schedule is not sent back to the trade scheduler module and is only held in abeyance until a suitable broker/algorithm is recommended. Once the suitable broker/algorithm has been selected, the approved schedule can then be transmitted to that selected broker for execution. Depending on the implementation, the trade scheduler module 70 may be configured such that it is aware enough of the constraints such that it can determine if it can find a satisfying/suitable schedule. For such an implementation, the evaluator module is used to provide numerical estimates as to how the generated schedule will perform.

It should also be clear that the input data may detail the number of brokers needed as well as how many brokers from which to choose from. As well, this input data may detail how many assets to be traded/sold per transaction (i.e. lot size), the identity of each of the assets in both the current portfolio and the desired portfolio, the size or number of each asset in both the current and the desired portfolio, and the price of each asset referred to in either the current portfolio and the desired portfolio.

In addition to the above, the system may use various models for market behaviour, asset price behaviour, as well as the behaviour of the various components affected/used by the system.

The simulator noted above that may be used with the module 140 can be used to estimate the market impact of the various transactions listed in the schedule. In addition to determining the impact (if any) of the transactions, the simulator may also be used to perform what-if scenarios that involve not just large transactions but also varying sizes of transactions and varying timings of transactions.

Regarding the evaluator module, the module may use multiple models by which to evaluate the generated schedule. The evaluator module would use one or more of these models to determine if the generated schedule results in the desired end result. These or other models would be used to assess whether the generated schedule has such an impact on the markets/exchanges that asset prices are affected, thereby potentially lowering the value of the assets in the desired portfolio. Using one or more of the various market models, the evaluator module determines that the schedule's suitability and provides appropriate feedback about this suitability. The feedback becomes the basis for the next iteration of the schedule until a suitable version of the schedule is produced such that the resulting value of the assets in the desired portfolio is suitably higher than the value of the assets in the current portfolio (or using some other criteria). At this point, the evaluator module can then send feedback that the schedule is suitable and that the trade scheduler module can no longer improve on that the version of the schedule. It should be clear that the evaluator module may use the outputs of the simulator, the market conditions input, the input data entered in the input module, and any other data available to the system to produce its assessment of the generated schedule.

In one aspect of the present invention, there is provided a method for managing an asset portfolio. The steps in this method are detailed in FIG. 2. The method begins at step 200, that of receiving input data. As noted above, the input data may have a number of components including current portfolio data, desired portfolio data, execution time data, and constraints that are to govern the generation of a schedule for asset sales and purchases. The input data received is then processed and formatted as necessary so that it can be usable for later stages in the process (step 210). Once prepared, the input data is then sent to a trade scheduler module (step 220). At the same time, the trade scheduler module receives market conditions input detailing general conditions in one or more markets/exchanges that may affect the assets in the current or desired portfolios (step 230). As noted above, market conditions input may be derived from real-world market conditions, projected market conditions, simulated market conditions, or static market conditions. The trade scheduler module then generates a schedule that conforms to the constraints, taking into account the rest of the input data and the market conditions input (step 240).

Once the schedule has been generated, this schedule is then passed to an evaluator module that evaluates the schedule based on one or more models that seek to predict or mimic the behaviour of markets or exchanges to different transactions (step 250). Decision 255 is then taken—whether the generated schedule is suitable to be passed on to the next stages by the evaluator. If, based on these models, the schedule cannot be improved upon, then the iterated schedule is considered approved and is passed to the later stages of the system. If the iterated schedule is still considered to be flawed or can be improved upon, then the logic flow moves back to step 240 as an updated schedule is generated. This loop between steps 240-255 is iterated until a suitably acceptable schedule is iteratively generated based on the received input data, the received market conditions input, and the iterative feedback from the evaluator module. It should be clear that the evaluator module provides detailed feedback to the trade scheduler module as to why the generated schedule has been rejected. This feedback is then used as the basis for edits or amendments to the iterated schedule when iterating the next version of the schedule. Thus, for clarity, the trade scheduler module can generate a first version of a schedule based on the input data and the other inputs to be taken into account. This first version is then passed to the evaluator and, based on the internal workings of the evaluator (which may use multiple models to assess the schedule), the evaluator can provide feedback regarding the schedule. Should the feedback indicate issues with this first version of the schedule, the feedback is sent to the trade scheduler module. The trade scheduler module then amends the schedule to result in a second version of the schedule that is based on the received feedback and on the other data previously received. This second version is then evaluated and, if this version is still insufficient, the process is continuously iterated until an nth version of the schedule is assessed to be suitable (i.e. the best possible schedule given the constraints and all the data inputs). This best possible schedule is then passed on to the later stages of the system.

After the schedule has been evaluated to be suitable, the schedule is sent to the user (step 260). At the same time, the schedule is used to determine a suitable broker or brokers who will execute the trades detailed in the schedule (step 270). As noted above, this selection may be based on an analysis of each broker's trading history along with the costs associated with each broker. At the same time, specific trading algorithms used by each broker are also analyzed and a recommendation for which algorithms to use is also made (step 280). These trading algorithms may include POV, TWAP, VWAP, and others.

After one or more brokers have been selected and their trading algorithms also selected, these are passed on to the user (step 290). The user then assesses the evaluator-approved schedule along with the broker selection and the algorithm selection and decides if the schedule and selections are approved or not (decision 300). If the user does not approve of the selections or of the generated schedule, the user can then edit/amend the schedule (step 310) and sends the amended/edited schedule back to the trade scheduler module (step 320). As part of step 320, the performance of the amended schedule can be evaluated by the evaluator with the evaluator providing suitable performance metrics for the amended schedule. If the user approves the generated schedule, then the schedule is sent to the selected broker/brokers for execution. As noted above, depending on what the user has amended in the schedule or in the input data that generated the schedule, a new schedule may need to be generated. As well, if the user approves of the schedule but not of the recommended broker/algorithm, a new broker/algorithm may need to be selected without having to generate a new schedule.

It should be clear that the method of the present invention may be practiced without selecting a broker/algorithm. As such, steps 270-280 may be skipped without changing the overall structure of the method. If steps 270-280 are skipped, the schedule, once approved by the user, can be sent to specific brokers for execution. If this is done, then the broker may be free to select one or more algorithms by which the trades in the schedule are to be executed.

It should be clear that, while the present invention is described with respect to rebalancing an asset portfolio, it can also be used for other financial ends. As an example, the present invention can be used for acquiring a specific mix of assets in the desired portfolio, shifting positions in specific assets, and adjusting a portfolio's mix of assets. The present system may also be used to prepare contingency plans for specific assets or portfolios. As an example, if specific events or circumstances occur, e.g. the price for specific assets significantly change, the schedule generated may be implemented (e.g. “if the price of stock A drops by 100, execute the schedule generated to shift the portfolio mix from asset B to asset C with significant impact on the market”). Of course, the contingency schedule generated can be generated as a what-if scenario to predict/forecast how specific markets/exchanges will react to certain events.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for use in managing a portfolio of financial assets, the system comprising:
an input module for receiving input data, said input data comprising:
current portfolio data comprising details regarding assets in a current portfolio;
desired portfolio data comprising details regarding assets in a desired portfolio;
execution time data comprising details for at least an execution time window during which said current portfolio is to be converted into said desired portfolio;
portfolio management constraints detailing constraints that need to be followed when converting said current portfolio into said desired portfolio;
a management scheduler module receiving said input data, said scheduler module being for generating an asset management schedule, said asset management schedule including limits for buying and selling said assets in said current portfolio and in said desired portfolio;
an evaluator module for evaluating said asset management schedule to provide feedback to said management scheduler module based on a suitability of said asset management schedule for execution of one or more specific tasks;
wherein
said one or more specific tasks includes an optimization of an increase in asset value differences between said assets in said current portfolio and said assets in said desired portfolio;
said evaluator module and said management scheduler module iterate through different versions of said asset management module until a suitable version is considered acceptable by said evaluator;
said schedule subdivides said execution time window into specific time units and said schedule details one or more assets to be bought or sold within specific time units.

2. The system according to claim 1, wherein said system accepts user defined constraints including at least one of:
a maximum buying price for at least one specific asset in said desired portfolio;
a minimum selling price for at least one specific asset in said current portfolio;
a maximum number of assets to be bought per transaction;
a minimum number of assets to be sold per transaction;
a maximum number of assets to be sold per transaction;
a minimum number of assets to be bought per transaction;
risk constraints;
percentage of expected volume constraints; and
bid/ask spread constraints.

3. The system according to claim 1, wherein said scheduler module receives a market condition input that details conditions in at least one asset trading market and wherein said schedule is generated based at least on said market condition input.

4. The system according to claim 1, wherein said schedule details one or more exchanges where said assets are to be bought and sold.

5. The system according to claim 1, wherein said system includes a broker selection module, said broker selection module being for selecting one or more brokers to execute a buying and selling of said assets based on said schedule, said one or more brokers being selected based at least on a record of previous performance by said one or more brokers.

6. The system according to claim 5, wherein said system selects at least one trading method used by said one or more brokers to be used when executing asset sales and purchases according to said schedule.

7. The system according to claim 1, wherein said schedule generated by said system is sent to a user for approval.

8. The system according to claim 7, wherein said schedule is only sent to said user after said schedule has been evaluated by said evaluator module.

9. The system according to claim 1, wherein said evaluator module evaluates said schedule based on at least one of:
conditions in an asset trading market in which said assets are to be bought and sold according to said schedule, said conditions being derived from a market condition input;
said current portfolio data;
said desired portfolio data;
said execution time data;
said portfolio management constraints;
potential return on value calculations based on said current portfolio data and said desired portfolio data;
prices of assets in said current portfolio and in said desired portfolio;
a volume of said assets at least one of said current portfolio and said desired portfolio;
at least one model that seeks to mimic or predict a market's behaviour after transactions with specific characteristics have been performed.

10. A method for managing a financial asset portfolio, the method comprising:
receiving a trade order including at least one asset type, a corresponding portfolio weight envelope, and a corresponding execution timeline;
converting the portfolio weight envelope for the at least one asset type into a desired asset quantity envelope;
dividing the timeline into a plurality of expected trading sessions for at least one specific market;
distributing the desired asset quantity envelope among the number of expected trading sessions;
and
issuing at least one instruction to at least one broker, said at least one instruction being indicative of at least one distributed quantity to be traded during at least one of the plurality of trading periods.

11. The method according to claim 10, further including a step of selecting at least one broker based on machine-learning.

12. The method according to claim 10, further including a step of selecting at least one trading algorithm based on machine-learning.

13. The method according to claim 12, wherein said instruction comprises instructing said at least one broker to trade said at least one distributed quantity during said at least one of the plurality of trading periods using said at least one trading algorithm selected in claim 12.

14. The method according to claim 10, wherein at least one of said steps is executed based on machine learning.

15. The method of claim 10, wherein said distributing the desired asset quantity envelope is based on either a stochastic process or a non-deterministic adaptive process.

16. The method of claim 14, wherein said machine-learning comprises reinforcement learning.

17. The method of claim 10, further comprising simulating the current state of said at least one specific market based on market data.

18. The method of claim 10, further comprising simulating a resulting state of said at least one specific market based on a potential trade order placement.

19. The method of claim 10, further comprising simulating a resulting state of said at least one specific market based on a machine-learning recognition of at least one external factor.
